(19) United States
(12) Patent Application Publication
(10) Pub. No.: US 2026/0005501 A1
(43) Pub. Date: Jan. 1, 2026

(54) STUB-UP SUPPORT SYSTEM

(71) Applicant: IPEX TECHNOLOGIES INC., Mississauga (CA)

(72) Inventors: Mark Nicholas JUCHIMENKO, Toronto (CA); Martin Kwan Yu Leung, Oakville (CA)

(21) Appl. No.: 19/248,664

(22) Filed: Jun. 25, 2025

(30) Foreign Application Priority Data
Jun. 27, 2024 (CA) 3244675

(51) Int. Cl. H02G 3/00; E04G 21/18

(52) U.S. Cl. CPC H02G 3/263; E04G 21/185

(57) ABSTRACT

A stub-up support system including a first stub-up support and a second stub-up support. The first stub-up support and the second stub-up support each have a support body having a front form attachment portion, a rear form attachment portion, a raised support portion, and an intermediate support portion. A front tube support member extends from the front form attachment portion, the front tube support member having a front support surface for engaging with a bottom surface of a flexible tube. An intermediate tube support member extends from the intermediate support portion, the intermediate tube support member having an intermediate support surface for engaging with a top surface of the flexible tube. A raised tube support member extends from the raised support portion, the raised tube support member having a raised support surface for engaging with the bottom surface of the flexible tube.

### FIELD OF THE INVENTION

This invention relates to devices for bringing electrical conduits up through a concrete floor, and more particularly to a stub-up system for electrical non-metallic tubing.

### BACKGROUND OF THE INVENTION

When constructing a building, poured concrete is often used to form walls, floors, ceilings, and other constructional components. Electrical wires are sometimes embedded directly into the concrete, for example by running the wires through flexible tubing, such as electrical non-metallic tubing, and then pouring the concrete over the tubing.

Often it is necessary to pass an electrical conduit upwards through a concrete floor. In order to hold the electrical conduit upright, a makeshift support or stub-up support is sometimes fabricated on site.

The applicant has appreciated that the fabrication of stub-up supports on site is time consuming and increases costs. The supports also offer limited reliability and efficacy, and may not be compatible with the full range of conduit sizes that customers need. Furthermore, the supports may not be adequately fixed to the formwork, and often have a high risk of being damaged or moved out of place.

### SUMMARY OF THE INVENTION

It is an object of the present invention to provide an improved type of stub-up support system that at least partially overcomes some of the disadvantages of the prior art.

Accordingly, in one aspect the present invention resides in a stub-up support having a support body with a front form attachment portion, a rear form attachment portion spaced horizontally from the front form attachment portion, a raised support portion positioned vertically above the rear form attachment portion, and an intermediate support portion positioned between the front form attachment portion and the raised support portion. A front tube support member extends from the front form attachment portion, the front tube support member having a front support surface for engaging with a bottom surface of a flexible tube. An intermediate tube support member extends from the intermediate support portion, the intermediate tube support member having an intermediate support surface for engaging with a top surface of the flexible tube. A raised tube support member extends from the raised support portion, the raised tube support member having a raised support surface for engaging with the bottom surface of the flexible tube. The raised support surface is oriented between 45 and 120 degrees, and more preferably about 90 degrees, relative to the front support surface.

The applicant has appreciated that the stub-up support in accordance with the invention allows flexible tubing, such as electrical non-metallic tubing, to be supported for stub-ups without requiring makeshift supports to be manufactured on site.

The applicant has further appreciated that having three points of contact with the flexible tube, namely the front support surface engaging with the bottom surface of the flexible tube, the intermediate support surface engaging with the top surface of the flexible tube, and the raised support surface engaging with the bottom surface of the flexible tube, provides the required support to maintain the flexible tubing at the desired angle, usually 90 degrees relative to the concrete floor. The applicant has appreciated that having fewer than three points of contact may not provide the required level of support, with the result that the flexible tube may fall out of place. Having more than three points of contact may increase the size and material costs of the supports, and may also make it more difficult to insert the tubing into place between the support surfaces.

Preferably, the front support surface is spaced forwardly and downwardly relative to the intermediate support surface, and the intermediate support surface is spaced forwardly and downwardly relative to the raised support surface. In addition, the stub-up supports are preferably configured so that the top surface of the flexible tube is engaged only by the intermediate support surface, and the bottom surface of the flexible tube is engaged only by the front support surface and the raised support surface. The applicant has appreciated that this arrangement provides gaps between the support surfaces that preferably allows the tubing to be easily positioned into place, while also providing the required degree of support. The gaps also preferably allow the stub-up support to accommodate a range of different sizes of tubing.

Preferably, the stub-up supports each include at least one front attachment member for attaching the front form attachment portion to a formwork, and at least one rear attachment member for attaching the rear form attachment portion to the formwork. The attachment members may, for example, be in the form of a foot having a central opening for receiving a fastener, such as a nail. This preferably allows the stub-up supports to be securely fastened to the formwork, so that the supports remain in place and properly oriented during the concrete pouring process.

In another aspect, the invention resides in a stub-up support system that comprises at least a first stub-up support and a second stub-up support, and more preferably a plurality of stub-up supports. Preferably, the stub-up supports are all identical, allowing workers to become familiar with their features and uses, and increasing the efficiency of the construction process.

The stub-up supports each have a first side and a second side, and preferably have at least one connection element located on the first side and at least one complementary element located on the second side. The at least one connection element and the at least one complementary element are configured so that, when the first side of the first stub-up support is placed adjacent to the second side of the second stub-up support, the at least one connection element of the first stub-up support is connectable to the at least one complementary element of the second stub-up support. This allows the stub-up supports to be connected in series, with the result that a plurality of flexible tubes can be stubbed-up adjacent to each other in an organized and orderly manner. In some preferred embodiments, the connection element is a groove and the complementary element is a tongue. The tongue and groove have a complementary size and shape that allows the tongue of one stub-up support to be matedely received by the groove of an adjacent stub-up support.

Further aspects of the invention include:

A stub-up support system, which optionally incorporates one or more features of any one or more of the preceding and/or following aspects, comprising a first stub-up support and a second stub-up support, the first stub-up support and the second stub-up support each comprising: a support body having a front form attachment portion, a rear form attachment portion spaced horizontally from the front form attachment portion, a raised support portion positioned vertically above the rear form attachment portion, and an intermediate support portion positioned between the front form attachment portion and the raised support portion; a front tube support member that extends from the front form attachment portion, the front tube support member having a front support surface for engaging with a bottom surface of a flexible tube; an intermediate tube support member that extends from the intermediate support portion, the intermediate tube support member having an intermediate support surface for engaging with a top surface of the flexible tube; a raised tube support member that extends from the raised support portion, the raised tube support member having a raised support surface for engaging with the bottom surface of the flexible tube, the raised support surface being oriented between 45 and 120 degrees relative to the front support surface; at least one front attachment member for attaching the front form attachment portion to a formwork; and at least one rear attachment member for attaching the rear form attachment portion to the formwork; wherein the first stub-up support and the second stub-up support each have a first side and a second side, the first stub-up support and the second stub-up support each further comprising: at least one connection element located on the first side; and at least one complementary element located on the second side; wherein the at least one connection element and the at least one complementary element are configured so that, when the first side of the first stub-up support is placed adjacent to the second side of the second stub-up support, the at least one connection element of the first stub-up support is connectable to the at least one complementary element of the second stub-up support.

A stub-up support system, which optionally incorporates one or more features of any one or more of the preceding and/or following aspects, wherein, for each of the first stub-up support and the second stub-up support, the raised support surface is oriented about 90 degrees relative to the front support surface.

A stub-up support system, which optionally incorporates one or more features of any one or more of the preceding and/or following aspects, wherein the first stub-up support and the second stub-up support are identical.

A stub-up support system, which optionally incorporates one or more features of any one or more of the preceding and/or following aspects, wherein the first stub-up support and the second stub-up support are each configured so that the top surface of the flexible tube is engaged only by the intermediate support surface.

A stub-up support system, which optionally incorporates one or more features of any one or more of the preceding and/or following aspects, wherein the first stub-up support and the second stub-up support are each configured so that the bottom surface of the flexible tube is engaged only by the front support surface and the raised support surface.

A stub-up support system, which optionally incorporates one or more features of any one or more of the preceding and/or following aspects, wherein, for each of the first stub-up support and the second stub-up support: the support body has a rear surface that extends from the rear form attachment portion to the raised support portion; and the rear surface has a rear groove for receiving a rear fastening tie.

A stub-up support system, which optionally incorporates one or more features of any one or more of the preceding and/or following aspects, wherein, for each of the first stub-up support and the second stub-up support: the support body has a bottom surface that extends from the front form attachment portion to the rear form attachment portion; and the bottom surface has a bottom groove for receiving a bottom fastening tie.

A stub-up support system, which optionally incorporates one or more features of any one or more of the preceding and/or following aspects, wherein, for each of the first stub-up support and the second stub-up support: the support body has an opening that is positioned between the rear form attachment portion and the intermediate support portion; the support body has an inner surface that defines the opening; and the inner surface has an intermediate groove for receiving an intermediate fastening tie.

A stub-up support system, which optionally incorporates one or more features of any one or more of the preceding and/or following aspects, wherein, for each of the first stub-up support and the second stub-up support: the at least one connection element comprises a connection groove; and the at least one complementary element comprises a connection tongue.

A stub-up support system, which optionally incorporates one or more features of any one or more of the preceding and/or following aspects, wherein, for each of the first stub-up support and the second stub-up support, the at least one front attachment member comprises a first front attachment member located on the first side and a second front attachment member located on the second side.

A stub-up support system, which optionally incorporates one or more features of any one or more of the preceding and/or following aspects, wherein, for each of the first stub-up support and the second stub-up support: the second front attachment member is spaced forwardly from the first front attachment member; the at least one connection element comprises a front connection element that is spaced forwardly from the first front attachment member; and the at least one complementary element comprises a front complementary element that is located on the second front attachment member.

A stub-up support system, which optionally incorporates one or more features of any one or more of the preceding and/or following aspects, wherein, for each of the first stub-up support and the second stub-up support, the at least one rear attachment member comprises a first rear attachment member located on the first side and a second rear attachment member located on the second side.

A stub-up support system, which optionally incorporates one or more features of any one or more of the preceding and/or following aspects, wherein, for each of the first stub-up support and the second stub-up support: the first rear attachment member is spaced forwardly from the second rear attachment member; the at least one connection element comprises a rear connection element that is spaced rearwardly from the first rear attachment member; and the at least one complementary element comprises a rear complementary element that is located on the second rear attachment member.

A stub-up support system, which optionally incorporates one or more features of any one or more of the preceding and/or following aspects, wherein, for each of the first stub-up support and the second stub-up support, the at least one front attachment member and the at least one rear attachment member each comprise a foot having a central opening for receiving a fastener.

A stub-up support system, which optionally incorporates one or more features of any one or more of the preceding and/or following aspects, wherein the system further comprises the flexible tube, and wherein the flexible tube comprises electrical non-metallic tubing.

A stub-up support system, which optionally incorporates one or more features of any one or more of the preceding and/or following aspects, wherein, for each of the first stub-up support and the second stub-up support: the front support surface is spaced forwardly and downwardly relative to the intermediate support surface; and the intermediate support surface is spaced forwardly and downwardly relative to the raised support surface.

A stub-up support system, which optionally incorporates one or more features of any one or more of the preceding and/or following aspects, wherein the first stub-up support and the second stub-up support are identical; wherein the first stub-up support and the second stub-up support are each configured so that the top surface of the flexible tube is engaged only by the intermediate support surface; and wherein the first stub-up support and the second stub-up support are each configured so that the bottom surface of the flexible tube is engaged only by the front support surface and the raised support surface.

A stub-up support system, which optionally incorporates one or more features of any one or more of the preceding and/or following aspects, wherein, for each of the first stub-up support and the second stub-up support: the support body has a rear surface that extends from the rear form attachment portion to the raised support portion; the rear surface has a rear groove for receiving a rear fastening tie; the support body has a bottom surface that extends from the front form attachment portion to the rear form attachment portion; the bottom surface has a bottom groove for receiving a bottom fastening tie; the support body has an opening that is positioned between the rear form attachment portion and the intermediate support portion; the support body has an inner surface that defines the opening; and the inner surface has an intermediate groove for receiving an intermediate fastening tie.

A stub-up support system, which optionally incorporates one or more features of any one or more of the preceding and/or following aspects, wherein, for each of the first stub-up support and the second stub-up support: the at least one front attachment member comprises a first front attachment member located on the first side and a second front attachment member located on the second side; the second front attachment member is spaced forwardly from the first front attachment member; the at least one connection element comprises a front connection groove that is spaced forwardly from the first front attachment member; the at least one complementary element comprises a front complementary tongue that is located on the second front attachment member; the at least one rear attachment member comprises a first rear attachment member located on the first side and a second rear attachment member located on the second side; the first rear attachment member is spaced forwardly from the second rear attachment member; the at least one connection element comprises a rear connection groove that is spaced rearwardly from the first rear attachment member; and the at least one complementary element comprises a rear complementary tongue that is located on the second rear attachment member.

A stub-up support system, which optionally incorporates one or more features of any one or more of the preceding and/or following aspects, wherein the system further comprises the flexible tube, and the flexible tube comprises electrical non-metallic tubing; wherein, for each of the first stub-up support and the second stub-up support: the first front attachment member, the second front attachment member, the first rear attachment member, and the second rear attachment member each comprise a foot having a central opening for receiving a fastener; the front support surface is spaced forwardly and downwardly relative to the intermediate support surface; the intermediate support surface is spaced forwardly and downwardly relative to the raised support surface; and the support body is formed from recycled polyvinyl chloride.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1 shows a left side perspective view of a stub-up support in accordance with a preferred embodiment of the present invention;

FIG. 2 shows a right side view of the stub-up support shown in FIG. 1;

FIG. 3 shows a right side perspective view of the stub-up support shown in FIG. 1;

FIG. 4 shows a right side view of the stub-up support shown in FIG. 1, with electrical non-metallic tubing shown being supported by the stub-up support;

FIG. 5 shows a right side perspective view of the stub-up support and electrical non-metallic tubing shown in FIG. 4;

FIG. 6 shows a left side perspective view of two stub-up supports as shown in FIG. 1 connected in series, each supporting an electrical non-metallic tube;

FIG. 7 is a top view of the two stub-up supports and electrical non-metallic tubes shown in FIG. 6;

FIG. 8 is a rear perspective view of the two stub-up supports and electrical non-metallic tubes shown in FIG. 6;

FIG. 9 is a front view of the two stub-up supports and electrical non-metallic tubes shown in FIG. 6; and

FIG. 10 is a rear view the two stub-up supports and electrical non-metallic tubes shown in FIG. 6.

### DETAILED DESCRIPTION OF THE DRAWINGS

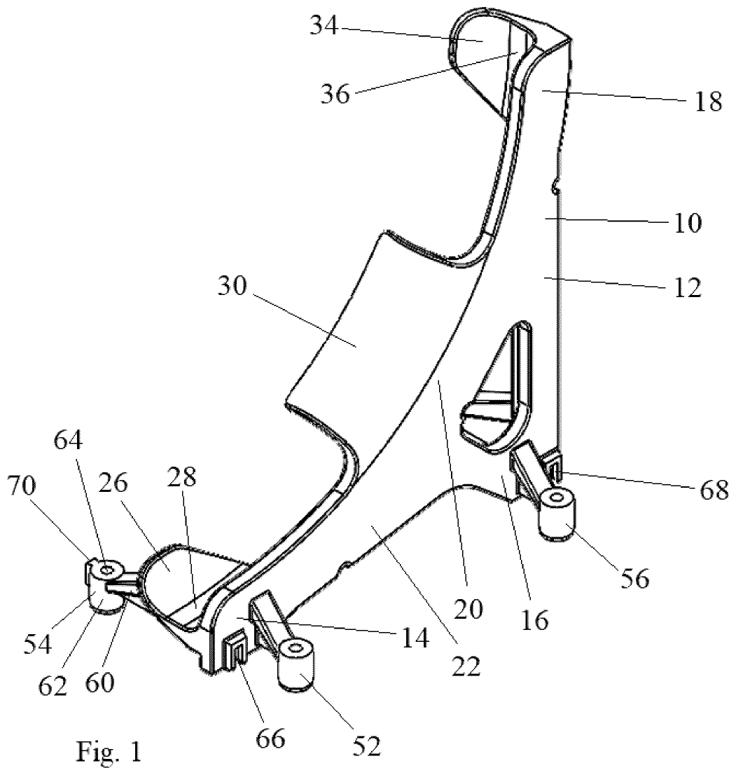

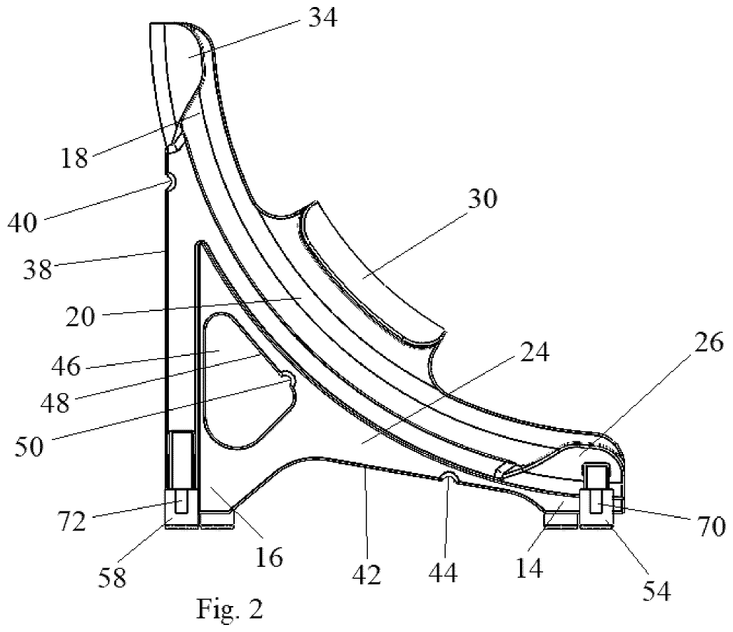

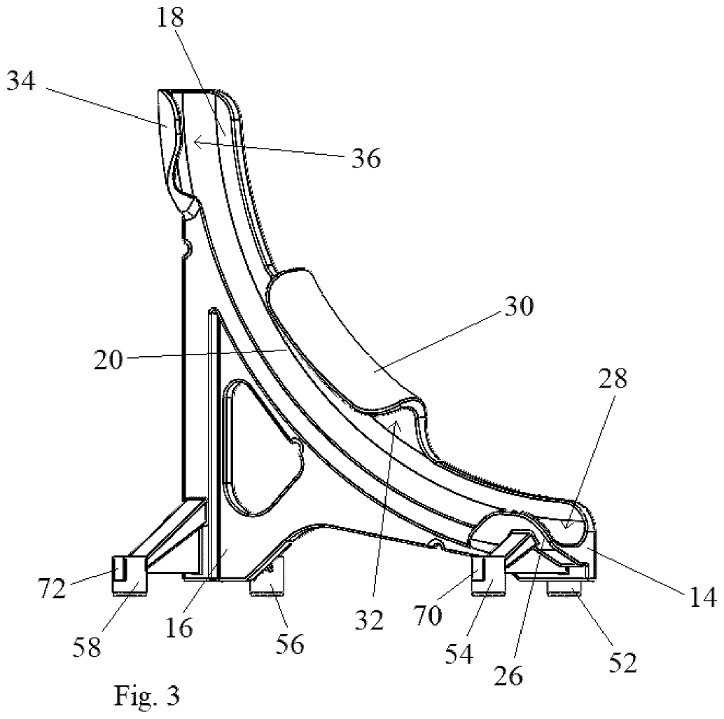

Reference is made to FIGS. 1 to 3, which show a stub-up support 10 in accordance with a preferred embodiment of the present invention. The stub-up support 10 has a support body 12 including a front form attachment portion 14, a rear form attachment portion 16 spaced horizontally from the front form attachment portion 14, a raised support portion 18 positioned vertically above the rear form attachment portion 16, and an intermediate support portion 20 positioned between the front form attachment portion 14 and the raised support portion 18. The support body 12 has a left side 22, also referred to herein as the first side 22, as can be seen in FIG. 1; and a right side 24, also referred to herein as the second side 24, as can be seen in FIGS. 2 and 3.

A front tube support member 26 extends to the right from the right side 24 of the front form attachment portion 14. The front tube support member 26 has a generally semi-cylindrical shape, with an upwardly facing front support surface 28.

An intermediate tube support member 30 extends to the right from the right side 24 of the intermediate support portion 20. The intermediate tube support member 30 also has a generally semi-cylindrical shape, and has an intermediate support surface 32 that faces diagonally rearwardly and downwardly. The intermediate support surface 32 is preferably angled about 135 degrees relative to the front support surface 28.

A raised tube support member 34 extends to the right from the right side 24 of the raised support portion 18. The raised tube support member 34 also has a generally semi-cylindrical shape, and has a raised support surface 36 that faces forwardly. The raised support surface 36 is preferably angled about 90 degrees relative to the front support surface 28.

As can be seen in FIG. 3, the front support surface 28 is spaced forwardly and downwardly relative to the intermediate support surface 32, and the intermediate support surface 32 is spaced forwardly and downwardly relative to the raised support surface 36.

As can be seen in FIG. 2, the support body 12 has a rear surface 38 that extends from the rear form attachment portion 16 to the raised support portion 18, and a bottom surface 42 that extends from the rear form attachment portion 16 to the front form attachment portion 14. The rear surface 38 has a rear groove 40 that is positioned below the raised tube support member 34 and above the intermediate tube support member 30. The bottom surface 42 has a bottom groove 44 that is positioned forwardly from the intermediate tube support member 30 and rearwardly from the front tube support member 26.

As can also be seen in FIG. 2, the support body 12 has an opening 46 that is positioned between the rear form attachment portion 16 and the intermediate support portion 20. The opening 46 is defined by an inner surface 48 of the support body 12. The inner surface 48 has an intermediate groove 50 on the side of the opening 46 that is closest to the intermediate tube support member 30.

As can be seen in FIG. 1, the stub-up support 10 has a first front attachment member 52 that extends to the left from the left side 22 of the front form attachment portion 14, and a second front attachment member 54 that extends to the right from the right side 24 of the front tube support member 26. As can be seen in FIGS. 1 and 3, the stub-up support 10 also has a first rear attachment member 56 that extends to the left from the left side 22 of the rear form attachment portion 16, and a second rear attachment member 58 that extends to the right from the right side 24 of the rear form attachment portion 16.

The first front attachment member 52, the second front attachment member 54, the first rear attachment member 56, and the second rear attachment member 58 each have a laterally extending leg portion 60 that attaches to a foot portion 62 having a generally cylindrical shape. Each foot portion 62 has a central opening 64 for receiving a fastener, such as a nail.

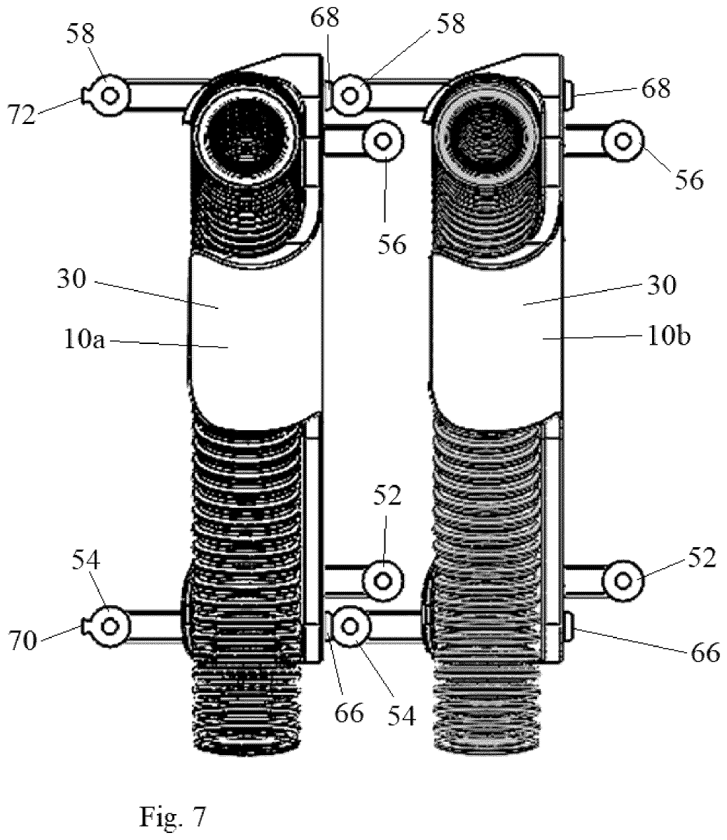

As can be best seen in FIG. 7, the second front attachment member 54 is positioned forwardly relative to the first front attachment member 52, and the first rear attachment member 56 is positioned forwardly relative to the second rear attachment member 58.

Referring again to FIG. 1, the stub-up support 10 also has a front connection groove 66 that is positioned on the left side 22 of the front form attachment portion 14, and a rear connection groove 68 that is positioned on the left side 22 of the rear form attachment portion 16. The front connection groove 66 is positioned forwardly from the first front attachment member 52, and the rear connection groove 68 is positioned rearwardly from the first rear attachment member 56. The first connection groove 66 and the second connection groove 68 are also referred to herein as the first connection element 66 and the second connection element 68.

As is best shown in FIG. 3, the stub-up support 10 also has a front complementary tongue 70 that is positioned on the right side 24 of the foot portion 62 of the second front attachment member 54, and a rear complementary tongue 72 that is positioned on the right side 24 of the foot portion 62 of the second rear attachment member 58. The front complementary tongue 70 and the rear complementary tongue 72 are also referred to herein as the front complementary element 70 and the rear complementary element 72.

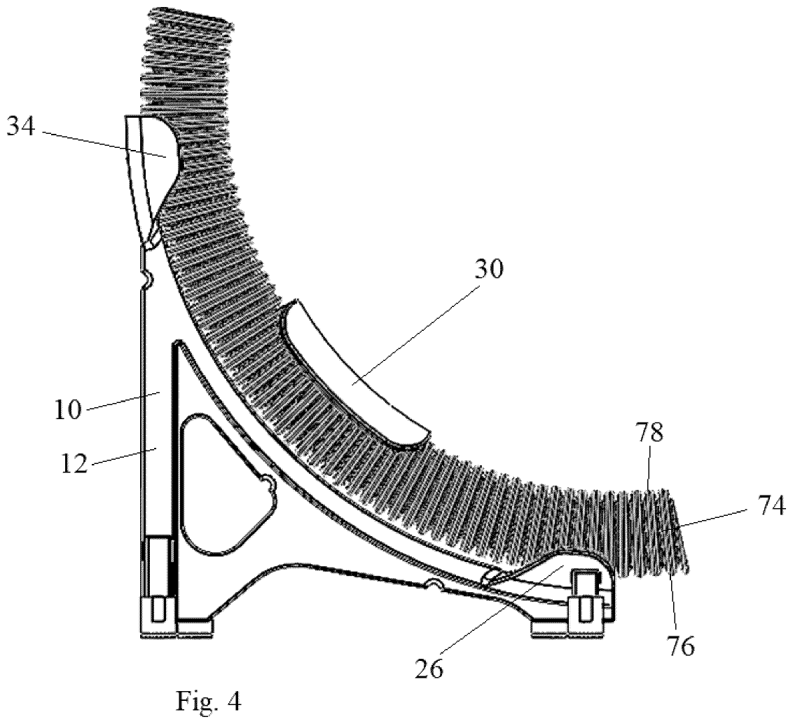

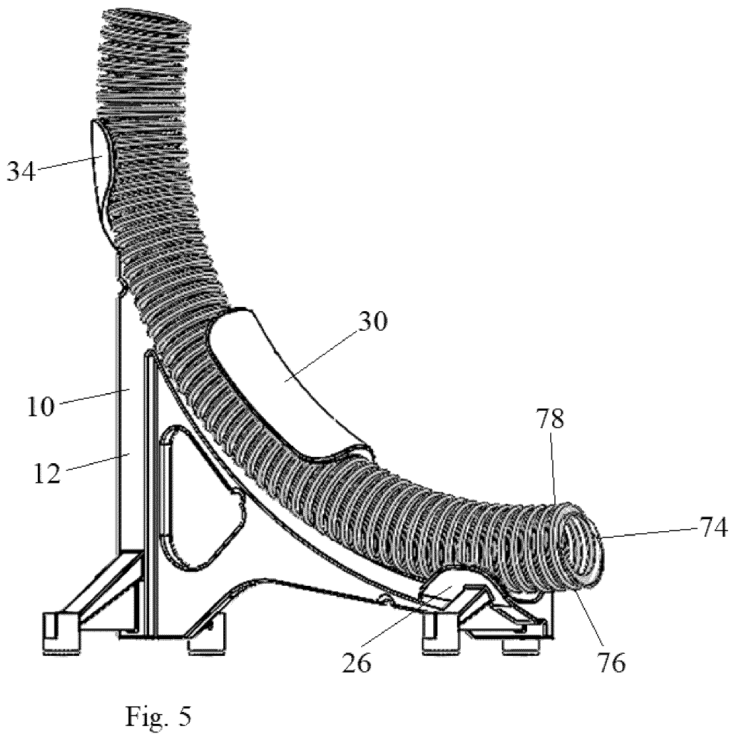

A preferred method of using the stub-up support 10 will now be described with reference to the Figures. The stub-up support 10 is preferably used to provide support for an electrical non-metallic tube 74, as shown in FIGS. 4 and 5. More specifically, the stub-up support 10 holds the tube 74 at a desired position and angle relative to a formwork for poured concrete, so that the tube 74 will emerge from the resulting concrete structure at the desired position and angle. In the preferred embodiment shown in the drawings, the stub-up support 10 is configured to hold the tube 74 bent at an angle of about 90 degrees.

Once the stub-up support 10 has been placed at the desired location, the support 10 can be fixed in place by fastening the attachment members 52, 54, 56, 58 to the formwork. The attachment members 52, 54, 56, 58 can be attached to the formwork by, for example, driving nails into the formwork through the central openings 64 of each foot portion 62. Other methods of securing the support 10 could also be used, such as connecting some or all of the attachment members 52, 54, 56, 58 to the formwork using cable ties or the like.

Once the stub-up support 10 is attached to the formwork, the tube 74 can then be positioned between the support members 26, 30, 34 in the arrangement as shown in FIGS. 4 and 5. The gaps between the support members 26, 30, 34 preferably makes it easy to slide the tube 74 in place. Once in place, the tube 74 is supported by the stub-up support 10 at three points of contact. In particular, the bottom surface 76 of the tube 74 engages with the front support surface 28 and the raised support surface 36, and the top surface 78 of the tube 74 engages with the intermediate support surface 32.

To further secure the tube 74 in place, fastening ties (not shown) can optionally be used to fasten the tube 74 to the stub-up support 10. More specifically, fastening ties can be received by one or more of the rear groove 40, the bottom groove 44, and the intermediate groove 50.

Once the tube 74 is secured to the stub-up support 10, and the stub-up support 10 is secured to the formwork, the concrete can then be poured. This embeds the tube 74 and the stub-up support 10 within the concrete, with the tube 74 emerging from the concrete at the desired position and angle.

Preferably, the stub-up support 10 as described above is one part of a stub-up support system, which includes a plurality of identical stub-up supports 10 that can be connected in series. The system can preferably be used to support a plurality of electrical non-metallic tubes 74 in a compact and orderly manner.

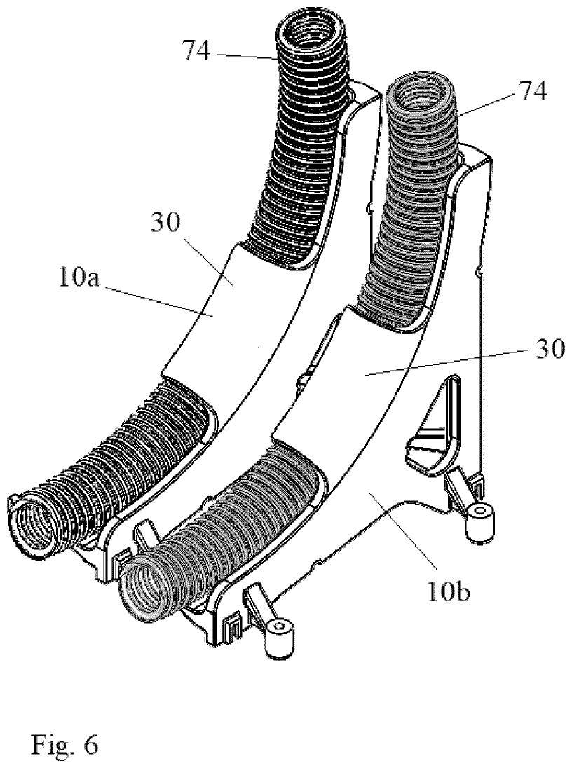

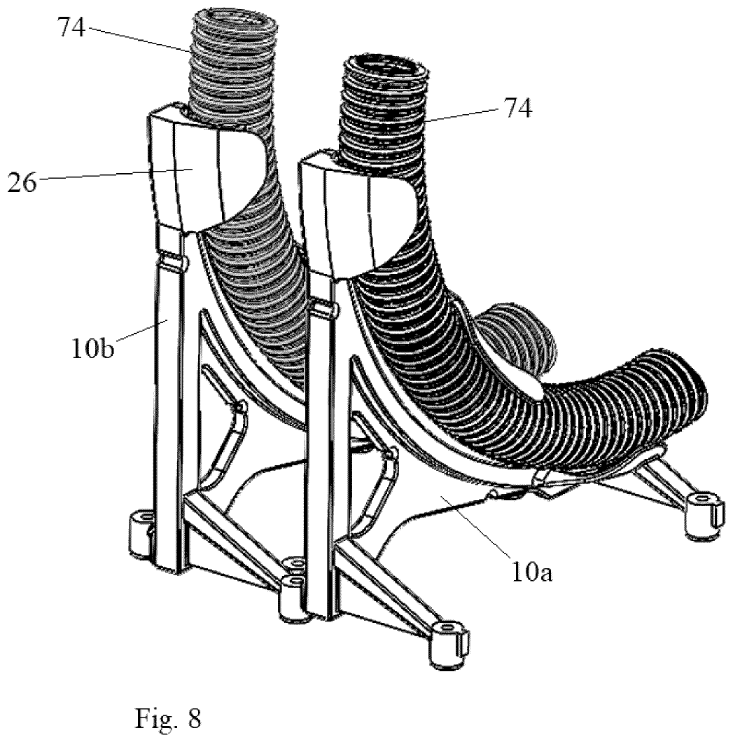

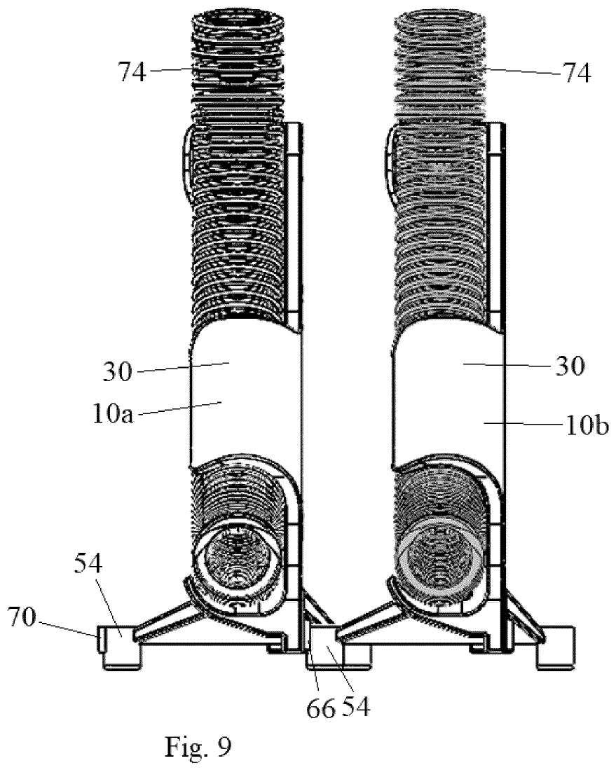

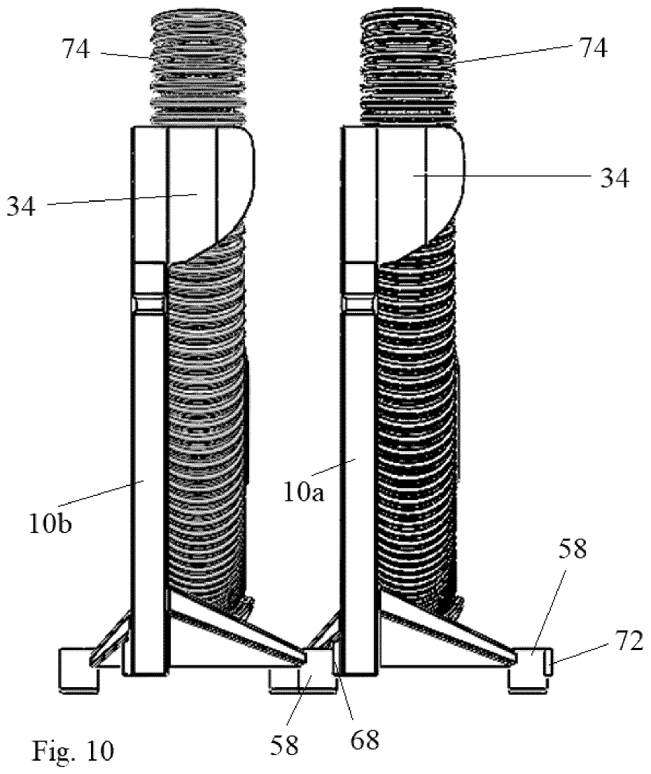

An example of a stub-up support system including a first stub-up support 10a and a second stub-up support 10b is shown in FIGS. 6 to 10. To connect the stub-up supports 10a, 10b in series, the left side 22 of the first stub-up support 10a is placed adjacent to the right side 24 of the second stub-up support 10b, with the front complementary tongue 70 of the second stub-up support 10b being received by the front connection groove 66 of the first stub-up support 10a, and the rear complementary tongue 72 of the second stub-up support 10b being received by the rear connection groove 68 of the first stub-up support 10a.

Connecting the adjacent stub-up supports 10a, 10b using the connection grooves 66, 68 and complementary tongues 70, 72 provides additional structural integrity to the assembly that helps to hold the tubes 74 at their desired positions and angles. Furthermore, as can be best seen in FIG. 7, the staggered positioning of the attachment members 52, 54, 56, 58 allows the first and second stub-up supports 10a, 10b to be positioned close together, without the first front attachment member 52 of the first stub-up support 10a interfering with the second front attachment member 54 of the second stub-up support 10b, and without the first rear attachment member 56 of the first stub-up support 10a interfering with the second rear attachment member 58 of the second stub-up support 10b.

It will be understood that, although various features of the invention have been described with respect to one or another of the embodiments of the invention, the various features and embodiments of the invention may be combined or used in conjunction with other features and embodiments of the invention as described and illustrated herein.

The invention is not limited to the particular structures of the preferred embodiments that have been shown in the drawings. For example, in some embodiments of the invention, the grooves 38, 40, 44 for connecting fastening ties could be omitted, as could the opening 46. The distances between the front tube support member 26, the intermediate tube support member 30, and the raised tube support member 34 could also be greater or smaller than what is shown in the drawings, for example to accommodate different sizes of tubing 74.

Any suitable form of connection elements 66, 68 and complementary elements 70, 72 that permit adjacent stub-up supports 10 to be connected in series could be used, and the invention is not limited to the particular structures shown in the drawings. For example, in an alternative embodiment the connection elements 66, 68 could be tongues instead of grooves, and the complementary elements 70, 72 could be grooves instead of tongues.

The attachment members 52, 54, 56, 58 could also have a different structure than is shown in the drawings. For example, the first front attachment member 52 could be positioned forwardly of the second front attachment member 54, and the first rear attachment member 56 could be positioned rearwardly of the second rear attachment member 58. The attachment members 52, 54, 56, 58 could also be smaller, larger, and/or have a different shape than what is shown in the drawings.

Although the drawings have only shown two stub-up supports 10 connected in series, it will be appreciated that three, four, five, or more stub-up supports 10 could be connected in the same manner.

Although this disclosure has described and illustrated certain preferred embodiments of the invention, it is to be understood that the invention is not restricted to these particular embodiments. Rather, the invention includes all embodiments which are functional or mechanical equivalents of the specific embodiments and features that have been described and illustrated herein.

1. A stub-up support system comprising a first stub-up support and a second stub-up support, the first stub-up support and the second stub-up support each comprising:
a support body having a front form attachment portion, a rear form attachment portion spaced horizontally from the front form attachment portion, a raised support portion positioned vertically above the rear form attachment portion, and an intermediate support portion positioned between the front form attachment portion and the raised support portion;
a front tube support member that extends from the front form attachment portion, the front tube support member having a front support surface for engaging with a bottom surface of a flexible tube;
an intermediate tube support member that extends from the intermediate support portion, the intermediate tube support member having an intermediate support surface for engaging with a top surface of the flexible tube;
a raised tube support member that extends from the raised support portion, the raised tube support member having a raised support surface for engaging with the bottom surface of the flexible tube, the raised support surface being oriented between 45 and 120 degrees relative to the front support surface;
at least one front attachment member for attaching the front form attachment portion to a formwork; and
at least one rear attachment member for attaching the rear form attachment portion to the formwork;
wherein the first stub-up support and the second stub-up support each have a first side and a second side, the first stub-up support and the second stub-up support each further comprising:
at least one connection element located on the first side; and
at least one complementary element located on the second side;
wherein the at least one connection element and the at least one complementary element are configured so that, when the first side of the first stub-up support is placed adjacent to the second side of the second stub-up support, the at least one connection element of the first stub-up support is connectable to the at least one complementary element of the second stub-up support.

2. The stub-up support system according to claim 1, wherein, for each of the first stub-up support and the second stub-up support, the raised support surface is oriented about 90 degrees relative to the front support surface.

3. The stub-up support system according to claim 1, wherein the first stub-up support and the second stub-up support are identical.

4. The stub-up support system according to claim 1, wherein the first stub-up support and the second stub-up support are each configured so that the top surface of the flexible tube is engaged only by the intermediate support surface.

5. The stub-up support system according to claim 4, wherein the first stub-up support and the second stub-up support are each configured so that the bottom surface of the flexible tube is engaged only by the front support surface and the raised support surface.

6. The stub-up support system according to claim 1, wherein, for each of the first stub-up support and the second stub-up support:
the support body has a rear surface that extends from the rear form attachment portion to the raised support portion; and
the rear surface has a rear groove for receiving a rear fastening tie.

7. The stub-up support system according to claim 1, wherein, for each of the first stub-up support and the second stub-up support:
the support body has a bottom surface that extends from the front form attachment portion to the rear form attachment portion; and
the bottom surface has a bottom groove for receiving a bottom fastening tie.

8. The stub-up support system according to claim 1, wherein, for each of the first stub-up support and the second stub-up support:
the support body has an opening that is positioned between the rear form attachment portion and the intermediate support portion;
the support body has an inner surface that defines the opening; and
the inner surface has an intermediate groove for receiving an intermediate fastening tie.

9. The stub-up support system according to claim 1, wherein, for each of the first stub-up support and the second stub-up support:
the at least one connection element comprises a connection groove; and
the at least one complementary element comprises a connection tongue.

10. The stub-up support system according to claim 1, wherein, for each of the first stub-up support and the second stub-up support, the at least one front attachment member comprises a first front attachment member located on the first side and a second front attachment member located on the second side.

11. The stub-up support system according to claim 10, wherein, for each of the first stub-up support and the second stub-up support:
the second front attachment member is spaced forwardly from the first front attachment member;
the at least one connection element comprises a front connection element that is spaced forwardly from the first front attachment member; and
the at least one complementary element comprises a front complementary element that is located on the second front attachment member.

12. The stub-up support system according to claim 11, wherein, for each of the first stub-up support and the second stub-up support, the at least one rear attachment member comprises a first rear attachment member located on the first side and a second rear attachment member located on the second side.

13. The stub-up support system according to claim 12, wherein, for each of the first stub-up support and the second stub-up support:
the first rear attachment member is spaced forwardly from the second rear attachment member;
the at least one connection element comprises a rear connection element that is spaced rearwardly from the first rear attachment member; and
the at least one complementary element comprises a rear complementary element that is located on the second rear attachment member.

14. The stub-up support system according to claim 1, wherein, for each of the first stub-up support and the second stub-up support, the at least one front attachment member and the at least one rear attachment member each comprise a foot having a central opening for receiving a fastener.

15. The stub-up support system according to claim 1, wherein the system further comprises the flexible tube, and wherein the flexible tube comprises electrical non-metallic tubing.

16. The stub-up support system according to claim 1, wherein, for each of the first stub-up support and the second stub-up support:
the front support surface is spaced forwardly and downwardly relative to the intermediate support surface; and
the intermediate support surface is spaced forwardly and downwardly relative to the raised support surface.

17. The stub-up support system according to claim 2, wherein the first stub-up support and the second stub-up support are identical;
wherein the first stub-up support and the second stub-up support are each configured so that the top surface of the flexible tube is engaged only by the intermediate support surface; and
wherein the first stub-up support and the second stub-up support are each configured so that the bottom surface of the flexible tube is engaged only by the front support surface and the raised support surface.

18. The stub-up support system according to claim 17, wherein, for each of the first stub-up support and the second stub-up support:
the support body has a rear surface that extends from the rear form attachment portion to the raised support portion;
the rear surface has a rear groove for receiving a rear fastening tie;
the support body has a bottom surface that extends from the front form attachment portion to the rear form attachment portion;
the bottom surface has a bottom groove for receiving a bottom fastening tie;
the support body has an opening that is positioned between the rear form attachment portion and the intermediate support portion;
the support body has an inner surface that defines the opening; and
the inner surface has an intermediate groove for receiving an intermediate fastening tie.

19. The stub-up support system according to claim 18, wherein, for each of the first stub-up support and the second stub-up support:
the at least one front attachment member comprises a first front attachment member located on the first side and a second front attachment member located on the second side;
the second front attachment member is spaced forwardly from the first front attachment member;
the at least one connection element comprises a front connection groove that is spaced forwardly from the first front attachment member;
the at least one complementary element comprises a front complementary tongue that is located on the second front attachment member;
the at least one rear attachment member comprises a first rear attachment member located on the first side and a second rear attachment member located on the second side;
the first rear attachment member is spaced forwardly from the second rear attachment member;
the at least one connection element comprises a rear connection groove that is spaced rearwardly from the first rear attachment member; and
the at least one complementary element comprises a rear complementary tongue that is located on the second rear attachment member.

20. The stub-up support system according to claim 19, wherein the system further comprises the flexible tube, and the flexible tube comprises electrical non-metallic tubing;
wherein, for each of the first stub-up support and the second stub-up support:
the first front attachment member, the second front attachment member, the first rear attachment member, and the second rear attachment member each comprise a foot having a central opening for receiving a fastener;
the front support surface is spaced forwardly and downwardly relative to the intermediate support surface;
the intermediate support surface is spaced forwardly and downwardly relative to the raised support surface; and
the support body is formed from recycled polyvinyl chloride.
